(19) United States
(12) Patent Application Publication
(10) Pub. No.: US 2009/0113073 A1
(43) Pub. Date: Apr. 30, 2009

(54) REMOTE ACCESS SYSTEM AND ITS IP ADDRESS ASSIGNING METHOD

(75) Inventors: Toshio Koide, Tokyo (JP); Norihito Fujita, Tokyo (JP)

Correspondence Address: NEC CORPORATION OF AMERICA, 6535 N. STATE HWY 161, IRVING, TX, 75039, US

(73) Assignee: NEC CORPORATION, Tokyo (JP)

(21) Appl. No.: 11/916,672

(22) PCT Filed: Jun. 2, 2006
(86) PCT No.: PCT/JP2006/311074

§ 371 Date: Dec. 6, 2007

(30) Foreign Application Priority Data
Jun. 7, 2005 (JP) 2005-166550

(51) Int. Cl. G06F 15/173

(52) U.S. Cl. 709/245

(57) ABSTRACT

An IP address assigning method for assigning a fixed address to a user terminal apparatus through a network in a system for remote accessing to the network to which a tunneling apparatus belongs from the user terminal apparatus. The user terminal apparatus connected to a first network requests a setting of a communication tunnel to the tunneling apparatus for remote accessing a second network. The tunneling apparatus receiving the request sends a DHCP message including a MAC address assigned to a physical NIC of the user terminal apparatus to a DHCP server connected to the network. The DHCP server sends a DHCP message including a fixed IP address corresponding to a preset MAC address. The tunneling apparatus assigns the IP address included in the received DHCP message to the user terminal apparatus.

### TECHNICAL FIELD

The present invention relates to a remote access system that uses a tunneling apparatus, and its IP address assigning method.

### BACKGROUND ART

In the Internet that represents information communication networks in recent years, most of user terminal apparatuses use IP (Internet Protocol) to carry out communications. An identifier referred to as the IP address is assigned to each of user terminal apparatuses. A network layer packet to be transmitted is transmitted to a destination terminal apparatus, which is specified by an assigned IP address. By specifying the IP address, a communication route in the Internet is chosen and the packet is transmitted to the designated terminal apparatus.

On the other hand, in order to assign the IP address to each of the user terminal apparatuses, a method referred to as DHCP (Dynamic Host Configuration Protocol) can be used. One example of an IP address assigning method based on DHCP will be described below with reference to FIG. 1.

FIG. 1 shows a sequence of messages which are transmitted and received between a user terminal apparatus 700 and a DHCP server apparatus 701 which are connected to the same LAN to assign an IP address to the user terminal apparatus. If the user terminal apparatus 700 and the DHCP server apparatus 701 are connected to the same LAN, the user terminal apparatus 700 broadcasts a Discover message 702 inside the LAN, in order to receive the assignment of the IP address.

The DHCP server apparatus 701, when receiving the Discover message 702, returns an Offer message 703, which includes information such as an IP address generated in accordance with a predetermined policy, to the user terminal apparatus 700. Here, when the DHCP server apparatus 701 stores in advance the correspondence between a MAC address and the IP address and then the Discover message 702 includes the MAC address of the user terminal apparatus 700 and further the DHCP server apparatus 701 returns the Offer message 703 including the fixed IP address corresponding to the MAC address of the user terminal apparatus 700, a fixed IP address is always assigned to the user terminal apparatus 700.

The user terminal apparatus 700, when receiving the Offer message 703 and its content can be admitted, broadcasts a Request message 704 including the admitted content. The DHCP server apparatus 701, when receives the Request message 704 and judges the received content being equal to the message transmitted by itself, returns an ACK message 705 to the user terminal apparatus 700. The user terminal apparatus 700, when receiving the ACK message 705, sets its own IP address in accordance with the content. As mentioned above, the assigning process for the IP address based on the DHCP is completed.

A plurality of DHCP server apparatuses 701 can exist in the same LAN. In this case, an offer message is chosen from the Offer messages 703 sent from the DHCP server apparatus 701 by the user terminal apparatus 700, and the chosen result is included into the Request message 704 and broadcasted.

The IP address assigning method when the user terminal apparatus and the DHCP server apparatus are connected to a same network is described as mentioned above. The IP address assigning method in a remote access system will be described below.

The remote access system is used in order to enable communication of user terminal apparatus that is brought into outside a LAN, as if it exists inside the LAN, by forming a communication tunnel and virtually extending the LAN. FIG. 2 shows one example of the remote access system that uses a remote access server system (also, referred to as a tunneling apparatus).

As shown in FIG. 2, when a user terminal apparatus 710 located at a remote position uses a remote access server system 712 and remotely accesses a LAN 716 through an information communication network (the Internet) 714, the same network information as the terminal connected to the LAN 716 is required to be set for the user terminal apparatus 710 so that the accessing can be executed under the same condition as the terminal connected to the LAN 716. Specifically, when a DHCP server apparatus 717 is connected to the LAN 716 and when the assignment of the IP address to the terminal accessing to the LAN 716 is managed by the DHCP server apparatus 717, the IP address belonging to the IP address range managed by the DHCP server apparatus 717 is required to be set for the user terminal apparatus 710.

However, the user terminal apparatus 710 and the DHCP server apparatus 717 cannot communicate directly. Thus, when the user terminal apparatus 710 requests the remote access server system 712 to set a communication tunnel 715 in order to access the LAN 716, the remote access server apparatus 712 executes an IP address assignment negotiation with the DHCP server apparatus 717 instead of the user terminal apparatus 710 and reports the IP address to the user terminal apparatus 710.

Japanese Laid Open Patent Application (JP-P 2001-136194A), Japanese Laid Open Patent Application (JP-P 2001-186136A) and Japanese Laid Open Patent Application (JP-P2001-285370A) disclose the above mentioned technique. A user terminal apparatus 710 assigns this IP address to a tunnel processing unit 711 and transmits a packet to or receives a packet from a tunnel processing unit 713 in a remote access server apparatus 712 through a communication tunnel 715. Thus, even from a remote position, a communication can be executed as if belonging to the LAN.

On the other hand, Japanese Laid Open Patent Application (JP-P 2003-249941A) discloses another conventional technique with regard to the assignment of the IP address. In this conventional technique, the MAC address of a user terminal apparatus (specifically, a camera) together with a camera name and the like is preliminarily registered in a DHCP server. Then, when the camera serving as a DHCP client connected to the LAN transmits the IP address assignment request, to which its own MAC address and the camera name and the like are added, to the DHCP server, the DHCP server uses the preliminarily registered MAC address and camera name and the like to carries out an authentication. If the authentication is successful, the IP address to be assigned is determined by using arbitrary method at that time and reported it to the camera. However, in this configuration, the different IP address is assigned each time the camera is connected to a new LAN.

### DISCLOSURE OF THE INVENTION

As mentioned above, in a remote access system, the remote access server apparatus executes the IP address assignment negotiation with the DHCP server apparatus instead of the user terminal apparatus. However, differently from the case in which the user terminal apparatus itself directly executed the IP address assignment negotiation with the DHCP server apparatus, the Discover message, which was requested to the DHCP server apparatus by the remote access server apparatus, did not include the MAC address of the user terminal apparatus. Thus, the same IP address could not be always assigned to the user terminal apparatus. In short, when the plurality of user terminal apparatuses existed, even if they are connected to any of networks, the corresponding fixed IP address could not be assigned to each of the user terminal apparatuses every time. This problem brings about a bad effect that the combination with the network for which an access policy based on the IP address is set is very difficult. For example, there is a problem that a connection through a remote access cannot be established for the server for which the policy for allowing only the connection from particular IP addresses is preliminarily set.

An object of the present invention is to enable a same IP address to be always assigned to a user terminal apparatus even in a remote access system.

An IP address assigning method of a remote access system includes the steps of: (a) a terminal apparatus connected to a first network requesting a setting of a communication tunnel to a tunneling apparatus connected to the first network and a second network for remote accessing the second network; (b) the tunneling apparatus obtaining a MAC address of the terminal network; (c) the tunneling apparatus sending a DHCP message including the MAC address of the terminal apparatus to the second network; (d) a DHCP server connected to the second network receiving the DHCP message and sending a response message including an IP address being preliminary set correspondingly to the MAC address included in the received DHCP message to the second network; and (e) the tunneling apparatus receiving the response message and reporting the IP address included in the received response message to the terminal apparatus.

At the step (c), the tunneling apparatus sets the MAC address of the terminal apparatus as a transmission source address and adds the transmission source address to the DHCP server. At the step (d), the DHCP server sets the MAC address of the terminal apparatus as a transmission destination MAC address in the response message. At the step (e), the tunneling apparatus receives the response message in a promiscuous mode at the step (e).

The step (b) includes: the tunneling apparatus receiving the MAC address of the terminal apparatus being sent from the terminal apparatus to the tunneling apparatus.

According to the IP address assigning method of the present invention, the communication tunnel is set in an IPsec tunnel mode. The terminal apparatus sends the MAC address to the tunneling apparatus in an IKE mode configuration.

According to the IP address assigning method of the present invention, the communication tunnel is set in an IPsec tunnel mode, and the terminal apparatus sends the MAC address of an own terminal apparatus to the tunneling apparatus by including the MAC address in an ISAKMP SA proposal.

According to the IP address assigning method of the present invention, the tunneling apparatus has a storage unit for storing the MAC address of the terminal apparatus. The step (b) includes the process for retrieving the MAC address of the terminal apparatus, which requests the setting of the communication tunnel, from the storage unit.

The tunneling apparatus according to the present invention includes: an IP address obtaining unit configured to send a DHCP message including an input MAC address to a second network, to receive a response message when a DHCP server apparatus receiving the DHCP message sent by the IP address obtaining unit has sent the response message which includes an IP address being preset correspondingly to the input MAC address included in the DHCP message to the second network, and to output the IP address included in the response message; and a capsulation unit configured to set a communication tunnel connecting the first network and the second network, obtaining a MAC address of a terminal apparatus connected to the first network when the terminal apparatus requests a setting of the communication tunnel, to output the obtained MAC address of the terminal apparatus as the input MAC address to the IP address obtaining unit, and to report an IP address outputted by the IP address obtaining unit to the terminal apparatus.

In the tunneling apparatus according to the present invention, the IP address obtaining unit sets the input MAC address as a transmission source MAC address of the DHCP message and receives the response message in a promiscuous mode.

In the tunneling apparatus according to the present invention, the capsulation unit obtains the MAC address of the terminal apparatus by receiving the MAC address of the terminal apparatus sent from the terminal apparatus to the tunneling apparatus.

The tunneling apparatus further includes a storage unit configured to store the MAC address of the terminal apparatus. The capsulation unit retrieves the MAC address of the terminal apparatus from the storage unit when the terminal apparatus requests a setting of the communication tunnel.

A terminal apparatus according to the present invention includes: a MAC address reporting unit configured to report a MAC address assigned to a physical network interface of a terminal apparatus to a tunneling apparatus when the terminal apparatus requests a setting of a communication tunnel to the tunneling apparatus for connecting a first network to a second network via the tunneling apparatus; and an IP address setting unit configured to receive an IP address from the tunneling apparatus and to assign the received IP address to a network interface for the communication tunnel.

In the terminal apparatus according to the present invention, the communication tunnel is set in an IPsec tunnel mode, and the MAC address setting unit sends the MAC address of the terminal apparatus to the tunneling apparatus by including the MAC address in a proposal of ISAKMP SA.

In the terminal apparatus according to the present invention, the communication tunnel is set in accordance with the IPsec tunnel mode, and the MAC address reporting means includes the MAC address into the proposal of ISAKMP SA and consequently transmits the MAC address of the terminal apparatus to the tunneling apparatus.

In the present invention, when the terminal apparatus connected to the first network requests the tunneling apparatus, which is connected to both of the first and second networks, to set the communication tunnel, in order to remotely access the second network, the tunneling apparatus obtains the MAC address of the terminal apparatus. This is specifically executed by receiving the MAC address transmitted to the tunneling apparatus from the terminal apparatus or retrieving a storage device for storing in advance the MAC address of the terminal apparatus. The tunneling apparatus transmits the DHCP message, which includes the thus-obtained MAC address of the terminal apparatus, to the second network. Then, when the DHCP server apparatus receives the DHCP message and transmits the response message, which includes the IP address preset correspondingly to the MAC address included in this received DHCP message, to the second network, the tunneling apparatus receives this response message and reports the IP address included in it to the terminal apparatus.

In this way, according to the present invention, without adding any change to a conventional DHCP server apparatus for assigning an IP address fixedly correlated to a MAC address, it is possible to assign a fixed IP address corresponding to the MAC address of the terminal apparatus, to the terminal apparatus which accesses from a remote position.

### BRIEF DESCRIPTION OF DRAWINGS

FIG. 1 is a sequence diagram of DHCP messages with regard to an IP address assignment when a user terminal apparatus is connected to the same network as a DHCP server apparatus;

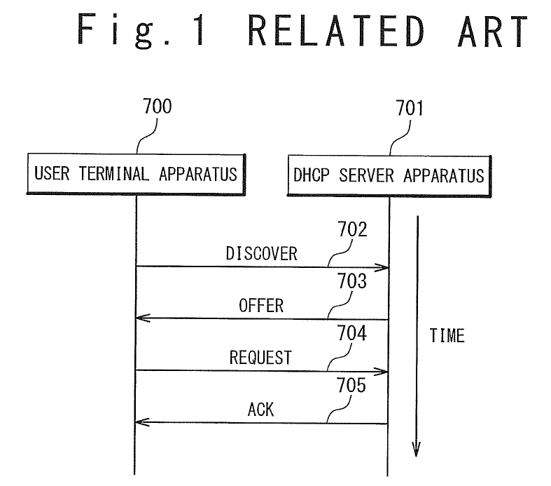

FIG. 2 is a block diagram showing the configuration of a remote access system;

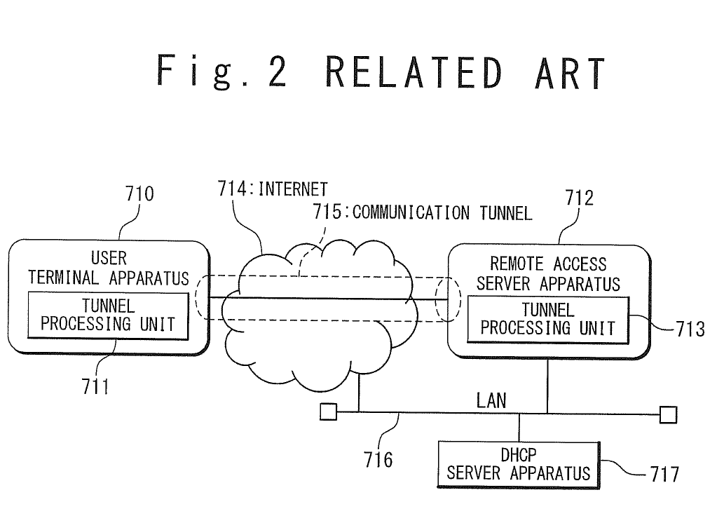

FIG. 3 is a block diagram showing the configuration of a first embodiment of the present invention;

FIG. 4 is a view showing an example of a content retained in a terminal address holding means;

FIG. 5 is a flowchart showing an operation of a user terminal apparatus in a first embodiment of the present invention;

FIG. 6 is a flowchart showing an operation of a capsulation means of a tunneling apparatus in a first embodiment of the present invention;

FIG. 7 is a flowchart showing an operation of an IP address obtaining means of a tunneling apparatus in a first embodiment of the present invention;

FIG. 8 is a flowchart showing an operation of a frame converting means of a tunneling apparatus in a first embodiment of the present invention;

FIG. 9A is a format diagram of packets and frames which are to be processed in a first embodiment of the present invention;

FIG. 9B is a format diagram of packets and frames which are to be processed in a first embodiment of the present invention;

FIG. 10 is a block diagram showing the configuration of a second embodiment of the present invention; and

FIG. 11 is a flowchart showing an operation of a capsulation means of a tunneling apparatus in a second embodiment of the present invention.

### BEST MODE FOR CARRYING OUT THE INVENTION

### First Embodiment

A first embodiment of the present invention will be described below in detail with reference to the drawings.

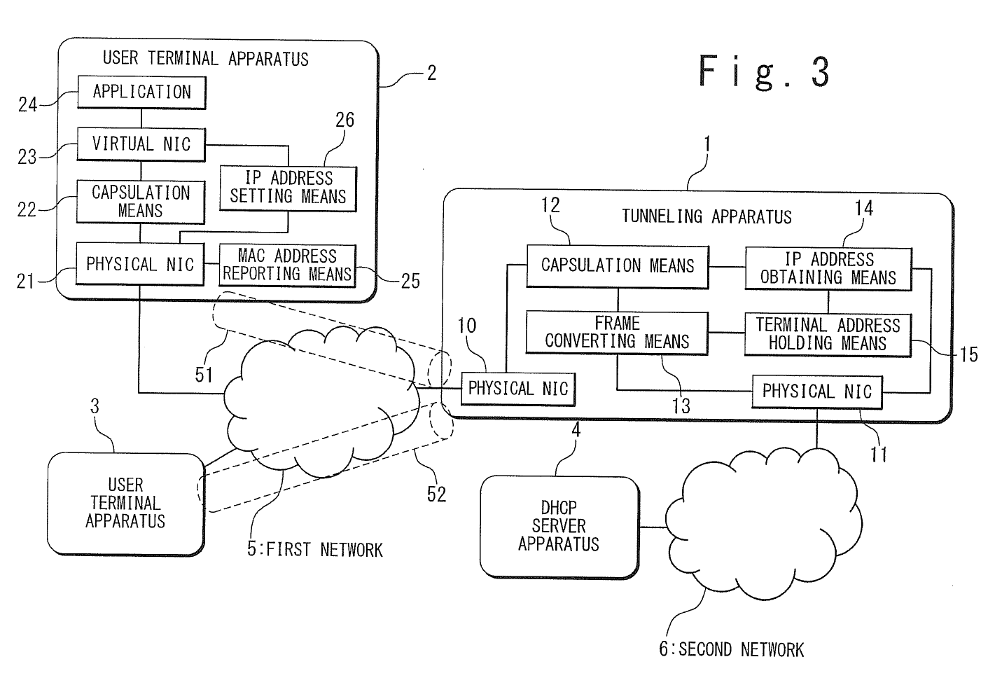

With reference to FIG. 3, the remote access system according to the first embodiment of the present invention is provided with: first and second networks 5, 6; user terminal apparatuses 2, 3; a DHCP server apparatus 4 connected to the second network 6; and a tunneling apparatus 1. Although two user terminal apparatuses 2, 3 are shown in FIG. 3, the number of the user terminal apparatuses is arbitrary.

The tunneling apparatus 1 is connected to both of the first network 5 and the second network 6. The tunneling apparatus 1 sets a communication tunnel 51 in which a network layer packet is encapsulated between itself and the user terminal apparatus 2 connected to the first network 5. Similarly, the tunneling apparatus 1 sets a communication tunnel 52 between itself and the user terminal apparatus 3. In short, the number same to the user terminal apparatuses of the communication tunnels are set. Hereafter, the user terminal apparatus 2 is focused in the following explanation. However, the explanation with regard to the user terminal apparatus 2 can be similarly applied to the user terminal apparatus 3.

Specifically, the tunneling apparatus 1 is a network apparatus that implements a tunneling protocol, such as a remote access server or the like, for terminating an IPsec gateway or PPP (Point-to-Point Protocol).

The tunneling apparatus 1 has a physical NIC (Network Interface Card) 10 connected to a first network 5, a physical NIC 11 connected to a second network 6, a capsulation means 12, a frame converting means 13, an IP address obtaining means 14 and a terminal address holding means 15.

The physical NIC 10 is an interface connected to the first network 5. Specifically, the physical NIC 10 is a wired or wireless network interface card, a cellular telephone, Personal Handyphone System, a modem or the like, and connected through any wired or wireless medium to the first network 5.

The physical NIC 11 is an interface for connecting to the second network 6. Specifically, the physical NIC 11 is a wired or wireless network interface card, and is connected through a wired or wireless medium to the second network 6.

The capsulation means 12 encapsulates or decapsulates a network layer packet that is transmitted and received between the second network 6 and the user terminal apparatus 2 and holds the communication tunnel 51. Also, the capsulation means 12 performs the authentication of user terminal apparatus 2, and if the user terminal apparatus 2 fails in the authentication, the communication tunnel 51 is not set, and the access to the second network 6 is inhibited.

The capsulation means 12 decapsulates a network layer packet transmitted from the user terminal apparatus 2. The capsulation means 12 outputs the network layer packet to the frame converting means 13. Reversely, the capsulation means 12 inputs a network layer packet and encapsulates the packet to output it to the user terminal apparatus. A user terminal apparatus, to which a network layer packet which is inputted from the frame converting means 13 and encapsulated is transmitted, is determined by the destination IP address of the network layer packet. That is, the encapsulated network layer packet is transmitted to the user terminal apparatus in which the destination IP address is assigned as the virtual NIC.

The capsulation means 12 outputs the MAC address of the physical NIC 21, which is reported by the user terminal apparatus 2 when the communication tunnel 51 is set, to the IP address obtaining means 14 and also reports the IP address, which is returned by the IP address obtaining means 14 as the response of the output, to the user terminal apparatus 2.

Specifically, the capsulation means 12 executes the encapsulating or decapsulating by using the IPsec tunnel mode if the tunneling apparatus 1 is an IPsec gateway, or by using the tunneling protocol such as PPP or the like if the tunneling apparatus 1 is a remote access server.

The frame converting means 13 carries out the conversion between a data link layer frame, which is transmitted and received in the second network 6, and the network layer packet which is transmitted and received in the communication tunnel 51. Specifically, for the network layer packet inputted from the capsulation means 12, the data link layer frame for which the MAC address assigned to the physical NIC 21 in the user terminal apparatus 2 of the transmission source is set as the transmission source MAC address is transmitted to the second network 6. When the transmission destination MAC address of the data link layer frame received from the second network 6 is the MAC address assigned to the physical NIC 21 of the user terminal apparatus 2, the MAC address is outputted as the network layer packet to the capsulation means 12.

The IP address obtaining means 14 receives the MAC address of the physical NIC 21 in the user terminal apparatus 2, which is transmitted when the user terminal apparatus 2 sets the communication tunnel 51, through the capsulation means 12 and transmits the DHCP message including the MAC address to the second network 6, and receives the IP address obtained as the response, and then outputs this IP address to the capsulation means 12, and also stores the set of the identifier of the user terminal apparatus 2, the IP address and the MAC address in the terminal address holding means 15.

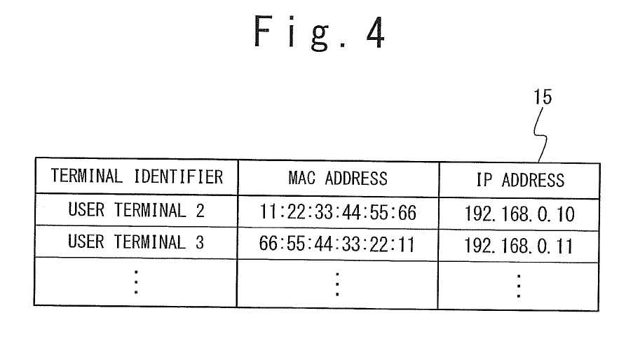

The terminal address holding means 15 is constituted by a storage unit for storing at least one or more sets of the identifier of the user terminal apparatus, the MAC address of the user terminal apparatus and the IP address assigned to the user terminal apparatus, as indicated by a symbol 150 in FIG. 4.

The user terminal apparatus 2 is an apparatus having a communication function and to which an IP address can be assigned, such as a computer or a cellular telephone, and is provided with a physical NIC 21, a capsulation means 22, a virtual NIC 23, an application 24, a MAC address reporting means 25 and an IP address setting means 26.

The physical NIC 21 is a physical interface for connecting to the first network 5. A wired or wireless network interface card, a cellular telephone, Personal Handyphone System, a modem can be exemplified as the physical NIC 21. The physical NIC 21 is connected through any wired or wireless medium to the first network 5.

The capsulation means 22 sets the communication tunnel 51 that is a virtual link to the capsulation means 12 of the tunneling apparatus 1 for transmitting and receiving packets through the physical NIC 21 of the user terminal apparatus 2, the first network 5 and the physical NIC 10 of the tunneling apparatus 1. The user terminal apparatus 2 can access the second network 6 by setting the communication tunnel 51. The communication tunnel 51 is set only after the tunneling apparatus 1 is authenticated. The capsulation means 22 carries out the encapsulating or decapsulating in accordance with the IPsec tunnel mode when the tunneling apparatus 1 is the IPsec gateway.

The virtual NIC 23 has the same interface as the physical NIC 21. The application 24 can use without distinguishing the difference between virtual NIC 23 and the physical NIC 21 and can to access the second network 6 through the communication tunnel 51. The virtual NIC 23 can hold an address such as an IP address and the like. The address is reported from the tunneling apparatus 1 and set by the IP address setting means 26.

The MAC address reporting means 25 reports the MAC address assigned to the physical NIC 21 to the tunneling apparatus 1 and sets the communication tunnel 51.

The IP address setting means 26 receives the IP address assigned to the own terminal apparatus 2 from the tunneling apparatus 1 and assigns to the virtual NIC 23.

Here, when the tunneling apparatus 1 is an IPsec gateway, after Phase 1 of IKE, at the stage for carrying out the ISAKMP Configuration Method (Mode Configuration), the MAC address of the physical NIC 21 can be reported from the MAC address reporting means 25 in the user terminal apparatus 2 to the tunneling apparatus 1 by using ISAKMP_CFG_SET. In this case the following procedure can be adopted. The tunneling apparatus 1 receiving this report uses ISAKMP_CFG-ACK, carries out a reception acknowledgement, and transmits the DHCP message including the above mentioned MAC address to the second network 6, and then reports the IP address obtained as a response to the message by using ISAKMP_CFG_SET to the user terminal apparatus 2. The IP address setting means 26 of the user terminal apparatus 2 received this IP address and assigns it to the virtual NIC 23 and returns ISAKMP_CFG_ACK as the reception check.

Also, as for the reports of the MAC address and the Ip address, both or one of them may be carried out in accordance with the request based on ISAKMP_CFG_REQUEST and the reply based on ISAKMP_CFG_REPLY.

The attribute for reporting the MAC address is not defined at this time. Thus, this attribute is carried out by using a region (16 to 16383) which is already reserved for a future use or a region (16384 to 32767) which is already reserved for a private use. As an attribute name, the use of INTERNAL_MAC_ADDRESS is recommended.

The DHCP server apparatus 4 is connected to the second network 6 and assigns an IP address to apparatuses connected inside the second network 6. The DHCP server apparatus 4 in this embodiment stores in advance a correspondence table between the MAC addresses and the IP addresses and has a static IP address assigning function for assigning a fixed IP address to a specified terminal at any time. Specifically, the DHCP server apparatus 4 receives a DHCP message broadcasted to the second network 6, retrieves a preset fixed IP address from the correspondence table by using the MAC address included in the received DHCP message as a key and then returns the retrieved IP address to the transmission source of the DHCP message. By combining this static IP address assigning function and the tunneling apparatus 1 according to the present invention, a fixed IP address can be assigned to the user terminal apparatus 2 at any time.

The first network 5 is a wired or wireless medium to distribute information that is transmitted and received between interface units. Specifically, the first network 5 is a wide area network such as the Internet or the like.

The second network 6 is a wired or wireless medium to distribute information that is transmitted and received between interface units. Specifically, the second network 6 is a local area network constituted by the Ethernet (a registered trademark), IEEE802.3 series, IEEE802.11 series and the like.

The communication tunnel 51 is a communication link that is virtually installed between the capsulation means 22 in the user terminal apparatus 2 and the capsulation means 12 in the tunneling apparatus 1. Specifically, the communication tunnel 51 is a virtual link installed by using any tunneling protocol such as the PPP, the IPsec tunnel mode and the like. With the communication tunnel 51, the capsulation means 22, 12 are processed such as they are directly connected.

The communication tunnel 51 can be installed through the authentication, or in the case of the failure in the authentication, the installation can be disallowed. For example, in the case of the IPsec tunnel mode, the following setting can be adopted: A user authentication based on XAUTH is carried out after Phase 1, and in the case of the failure, the already-established ISAKMP SA is cancelled to stop the establishment of IPsec SA.

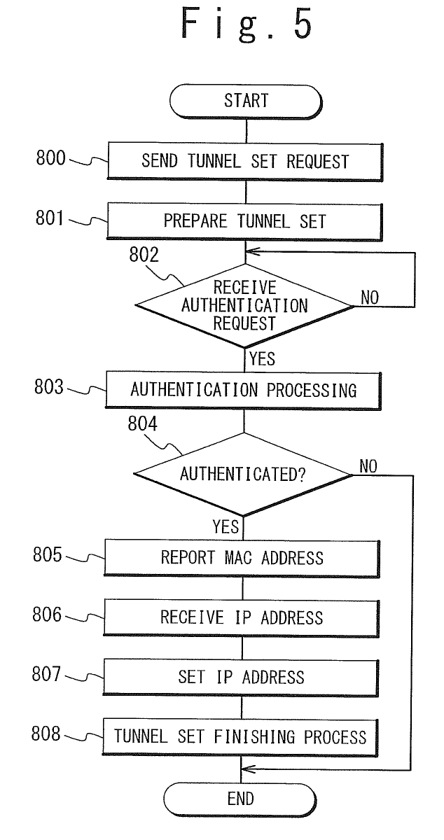

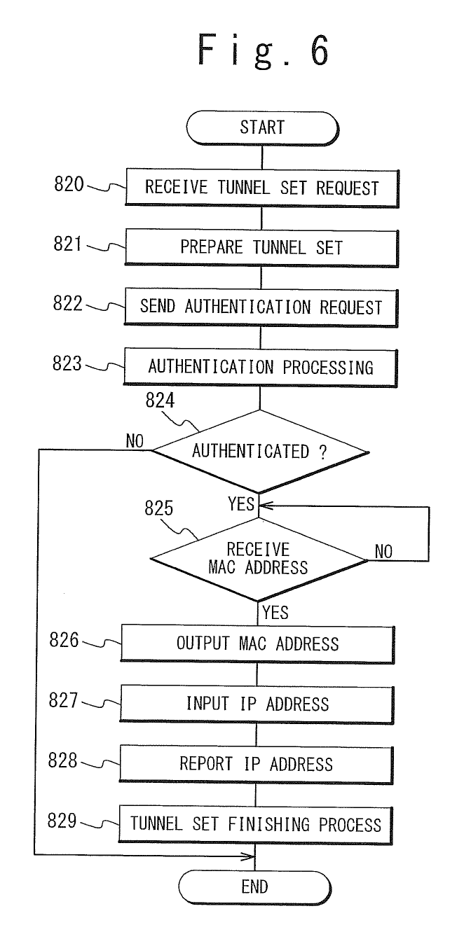

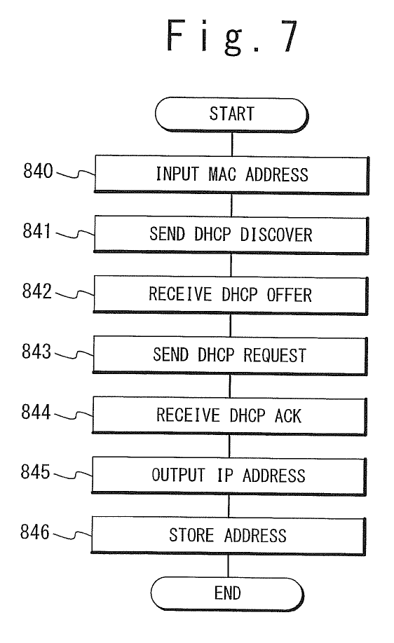

The operations from the tunnel setting request to the tunnel setting completion in this embodiment will be described below in detail with reference to FIGS. 3, 5, 6 and 7. FIG. 5 is a flowchart showing the operation of the capsulation means 22 in the user terminal apparatus 2. FIG. 6 is a flowchart showing the operation of the capsulation means 12 in the tunneling apparatus 1. FIG. 7 is a flowchart showing the operation of the IP address obtaining means 14 in the tunneling apparatus 1.

The user terminal apparatus 2, when accessing the second network 6, uses the capsulation means 22 to request the tunneling apparatus 1, which can communicate with the user terminal apparatus 2 through the first network 5, to set the communication tunnel 51 (Step 800). When the capsulation means 12 of the tunneling apparatus 1 receives this request (Step 820), a setting preparation process for the communication tunnel 51 is executed in both of them (Steps 801, 821). When the tunneling apparatus 1 is an IPsec gateway, the setting preparation process for the communication tunnel 51 implies the IKE Phase 1.

When the preparation process for setting the communication tunnel 51 has been completed, the capsulation means 12 of the tunneling apparatus 1 requests an authentication of the user terminal apparatus 2 (Step 822). When the capsulation means 22 of the user terminal apparatus 2 receives the request of this authentication (Step 802), both of them perform the authenticating process (Steps 803, 823). If the authentication is successfully completed, the flow of the process proceeds to the next step. In the case of the failure, the flow of the process is finished (Steps 804, 824). This authenticating process may be omitted. If the tunneling apparatus 1 is an IPsec gateway, this step indicates the user authentication based on XAUTH.

Next, the MAC address reporting means 25 of the user terminal apparatus 2 reports the MAC address assigned to its own physical NIC 21 to the capsulation means 12 of the tunneling apparatus 1 (Step 805). The capsulation means 12 of the tunneling apparatus 1 receives this report (Step 825). The capsulation means 12 of the tunneling apparatus 1 outputs the received MAC address to the IP address obtaining means 14 (Step 826). The IP address obtaining means 14 receives this (Step 840). When the tunneling apparatus 1 is an IPsec gateway, the ISAKMP Configuration Method (Mode Configuration) is used to report the MAC address of the physical NIC 21 from the MAC address reporting means 25 of the user terminal apparatus 2 by ISAKMP_CFG_SET. The capsulation means 12 of the tunneling apparatus 1 that receives this MAC address carries out the reception acknowledgement in accordance with ISAKMP_CFG_ACK and outputs the received MAC address to the IP address obtaining means 14. The IP address obtaining means 14 receives this MAC address. The report of the MAC address and its acknowledge response may be carried out by using the request based on ISAKMP_CFG_REQUEST and the reply based on ISAKMP_CFG_REPLY. Moreover, the reporting may be carried out by including the MAC address into an ISAKMP SA proposal.

The IP address obtaining means 14 of the tunneling apparatus 1 broadcasts a DHCP Discover message 702 including the received MAC address, as the frame in which the received MAC address is the transmission source MAC address, to the second network 6 (Step 841). The reason why the transmission source MAC address of the DHCP message is converted into the MAC address of the user terminal apparatus 2 in this way is to make a switching hub (not shown) inside the second network 6 connected between the tunneling apparatus 1 and the DHCP server apparatus 4 learn the MAC address of the physical NIC of the user terminal apparatus 2. Thus, hereafter, the frame whose destination is the MAC address of the user terminal apparatus 2 are all routed to the tunneling apparatus 1. Through this mechanism, a DHCP Offer message is also routed to the tunneling apparatus 1. The tunneling apparatus 1 receives them (specifically, the physical NIC 11 is set at the promiscuous mode, in which all frames with destination MAC addresses even the destination being not own address are received). Hereafter, similarly, by transmitting and receiving messages to and from the DHCP server apparatus 4, the IP address corresponding to the MAC address of the user terminal apparatus 2 is obtained.

The DHCP server apparatus 4 receives the DHCP Discover message 702 and retrieves the fixedly set IP address correspondingly to the included MAC address and then transmits a DHCP Offer message 703 including the retrieved IP address to the second network 6. The transmission destination MAC address of the frame in this DHCP Offer message is set at the MAC address of the user terminal apparatus 2. However, with the foregoing reason, this is routed to the tunneling apparatus 1. The tunneling apparatus 1 set at the promiscuous mode receives all of the frames even destined not to itself in the physical NIC 11 and reports the frame to the IP address obtaining means 14. The IP address obtaining means 14 analyzes the received frame and obtains the DHCP Offer message transmitted from the DHCP server apparatus 4 (Step 842).

The IP address obtaining means 14, when the content of the received DHCP Offer message 703 is appropriate, broadcasts a DHCP Request message 704 to the second network 6 in order to report that the message is accepted (Step 843).

The DHCP server apparatus 4 receives the DHCP Request message 704 and transmits a DHCP ACK message 705 to the second network 6. Then, the IP address obtaining means 14 of the tunneling apparatus 1 receives this message (Step 844).

The IP address obtaining means 14 outputs the obtained IP address to the capsulation means 12 (Step 845). Also, a set of the identifier of the user terminal apparatus, the MAC address and the IP address is stored in the terminal address holding means 15 (Step 846).

The capsulation means 12 of the tunneling apparatus 1 receives an IP address from the IP address obtaining means 14 (Step 827) and reports this IP address to the user terminal apparatus 2 (Step 828). The IP address setting means 26 of the user terminal apparatus 2 receives the IP address from the tunneling apparatus 1 (Step 806) and sets this IP address for its own virtual NIC 23 (Step 807). Then, the respective capsulation means 23, 12 carry out the setting completion process for the communication tunnel 51 (Steps 808, 829). When the setting of the communication tunnel 51 has been completed, the communication is established.

Here, when the tunneling apparatus 1 is an IPsec gateway, the IP address is reported in accordance with ISAKMP_CFG_SET. The user terminal apparatus 2 receives this IP address and may return ISAKMP_CFG_ACK as the reception acknowledgement. Also, the report of the IP address may be carried out in accordance with the request based on ISAKMP_CFG_REQUEST and the reply based on ISAKMP_CFG_REPLY.

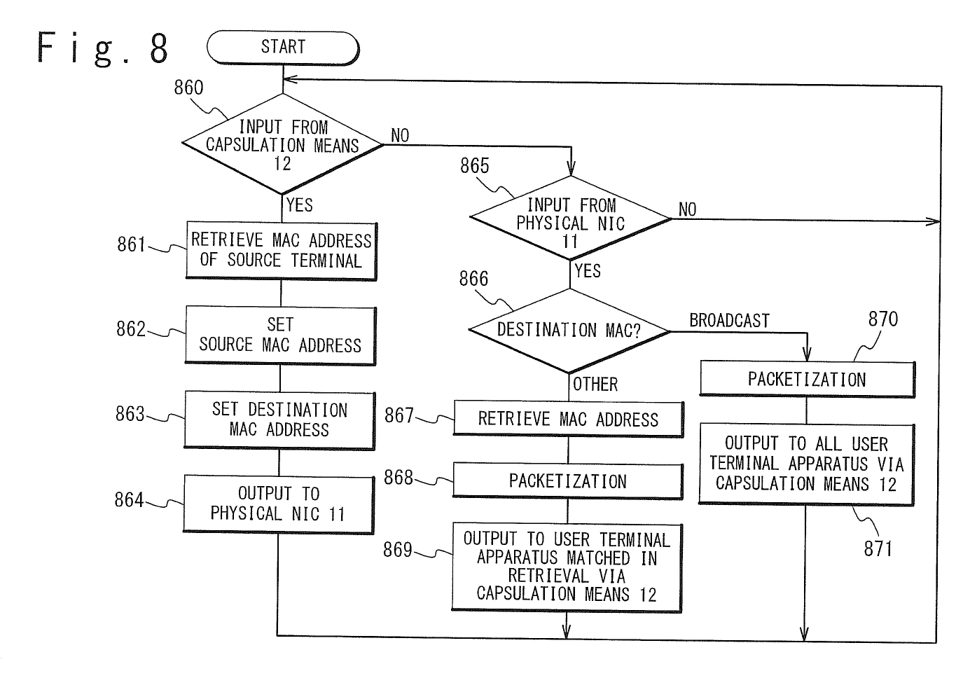

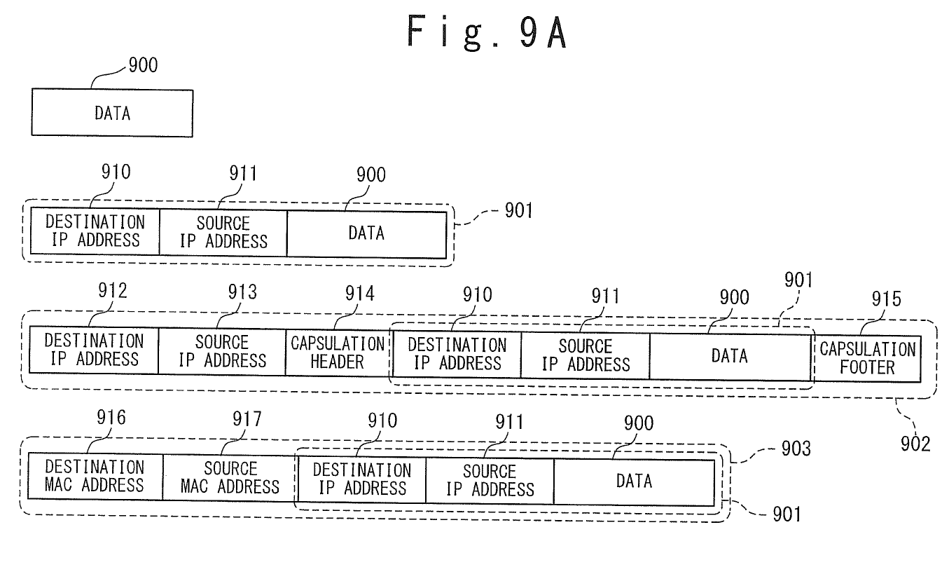

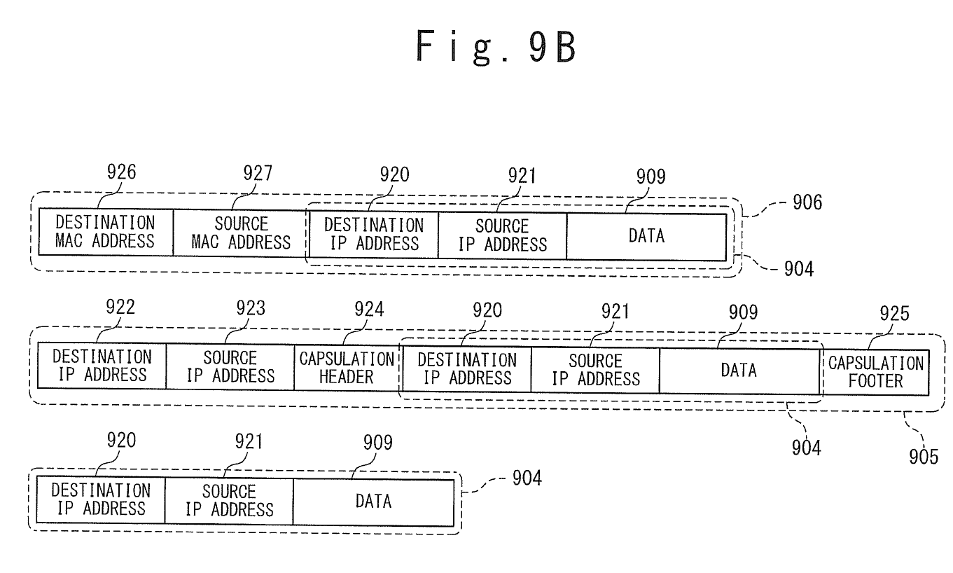

The operation when the user terminal apparatus 2 accesses the second network 6 after the setting of the communication tunnel 51 will be described below in detail with reference to FIGS. 3, 8, 9A and 9B. FIG. 8 is a flowchart showing an operation of the frame converting means 13 of the tunneling apparatus 1. FIG. 9A and FIG. 9B are format diagrams of the packet and the frame which are processed in the embodiment shown in FIG. 3.

With reference to FIGS. 3, 9A and 9B, the application 24 of the user terminal apparatus 2 forms a packet 901 in order to transmit a data 900 and outputs the packet to the virtual NIC 23. A destination IP address 910 at this time is the IP address of a partner to which the data 900 is sent. A transmission source IP address 911 is the IP address assigned to the virtual NIC 23, namely the IP address belonging to the second network 6. Thus, the application 24 can carry out the accessing that uses an address of the second network 6. In succession, the packet 901 is outputted to the capsulation means 22. The capsulation means 22 carries out an encapsulating process for the packet 901 to form a packet 902. For example, a destination IP address 912 is assumed to be the IP address assigned to the physical NIC 10 of the tunneling apparatus 1, and a transmission source IP address 913 of assumed to be the IP address assigned to the physical NIC 21 of the user terminal apparatus 2. Then, the packet 902 in which the original packet 901 is included with a capsulation header 914 and a capsulation footer 915 is formed. The packet 902 is received by the physical NIC 10 of the tunneling apparatus 1, decapsulated by the capsulation means 12 to be converted into the packet 901 and then outputted to the frame converting means 13.

When the packet 901 is inputted to the frame converting means 13, if it is inputted from the capsulation means 12 (Step 860), the MAC address corresponding to the transmission source IP address 911 of the packet 901 is retrieved from the terminal address holding means 15 (Step 861), and the packet 901 is converted into a frame 903 in which the MAC address obtained as mentioned above is defined as a transmission source IP address 917 (Step 862).

A destination MAC address 916 sets the address corresponding to the destination IP address 910 (Step 863). As necessary, an ARP message is used to retrieve the MAC address corresponding to the destination IP address 910. If the destination IP address 910 is the broadcast IP address, the broadcast address is set for the destination MAC address 916.

The above-formed frame 903 is outputted to the physical NIC 11 (Step 864) and transmitted to the second network 6.

Reversely, a frame 906 sent from the second network 6 to the user terminal apparatus 2 is received by the physical NIC 11 in the tunneling apparatus 1 and then outputted to the frame converting means 13.

When the frame converting means 13 inputs the frame 906, when it is inputted from the physical NIC 11 (Steps 860, 865), the frame converting means 13 judges whether or not the destination MAC address 926 of the frame is the broadcast (Step 866).

If the destination MAC address 926 is the broadcast, the frame converting means 13 removes a data link layer header to extract a packet 904 (Step 870) and outputs the packet 904 together with a transmission instruction to all of the user terminal apparatuses to the capsulation means 12 (Step 871). The capsulation means 12 forms packets 905 by encapsulating the packets 904 so that they are respectively destined to the user terminal apparatuses, in accordance with the instruction, and then transmits them to all of the user terminal apparatuses. Specifically, a destination IP address 922 is set at the IP address assigned to the physical NIC 21 in each user terminal apparatus. Then, the packets 905 in which in each of them, a transmission source IP address 923 is set at the IP address assigned to the physical NIC 10 and whose number is equal to the number of the user terminal apparatuses are formed, and each of them is transmitted through the physical NIC 10 to the first network 5.

If the destination MAC address 926 is not the broadcast, the frame converting means 13 performs a retrieval from the terminal address holding means 15 by using the destination MAC address 926 as the key (Step 867), and only when the corresponding IP address is discovered, removes the data link layer header and makes into a packet (Step 868) and outputs the packet 904 together with the transmission instruction destined to the user terminal apparatus 2 coincident with the destination MAC address 926 to the capsulation means 12 (Step 869). The capsulation means 12 encapsulates the packet 904 and then transmits the packet to the user terminal apparatus 2 specified in accordance with the instruction. Specifically, the packet 905, in which the IP address that is held in the terminal address holding means 15 and corresponds to the destination MAC address 926 is defined as the destination IP address 922, and the IP address assigned to the physical NIC 10 is defined as the transmission source IP address 923, is formed. Then, the formed packet is transmitted through the physical NIC 10 to the first network 5.

As for the report of the MAC address and the IP address based on the ISAKMP Configuration Method (Mode Configuration) in the IPsec, Configuration Payload in IKEv2 and the like may be used. The processing procedure for the address report in IKEv2 is similar so that the explanation is skipped.

The effect of this embodiment will be described below.

In this embodiment, it is possible to assign a fixed IP address which corresponds to a MAC address of the physical NIC 21 of a user terminal apparatus 2 to the virtual NIC 23 of the user terminal apparatus 2 accessing from a remote position, without adding any modification to the DHCP server apparatus 4 which has a function to assign an IP address fixedly corresponding to a MAC address. Moreover, the user terminal apparatus 2 can perform as if it is physically connected to the second network 6.

### Second Embodiment

A second embodiment of the present invention will be described below in detail with reference to the drawings.

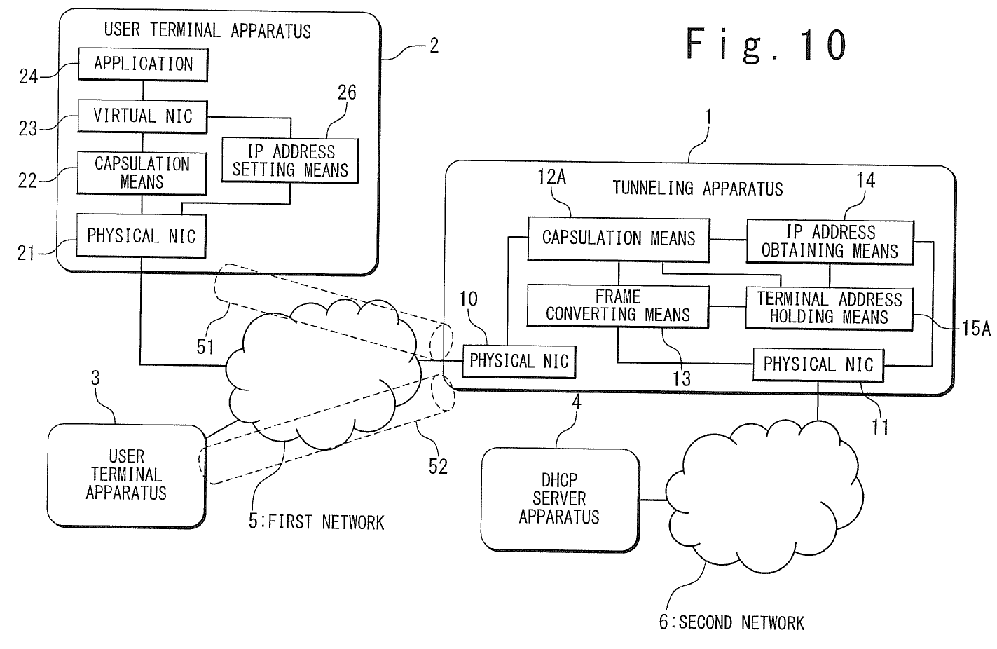

With reference to FIG. 10, in the remote access system according to the second embodiment of the present invention, the user terminal apparatus 2 does not contain the MAC address reporting means 25 described in the first embodiment, and the functions of the terminal address holding means 15A and the capsulation means 12A in the tunneling apparatus 1 partially differs from those corresponding to the first embodiment.

The terminal address holding means 15A of the tunneling apparatus 1 is a storage unit for holding a set of the identifier of a terminal and the MAC address and IP address of the terminal, as shown in FIG. 4 similarly to the first embodiment. However, the terminal address holding means 15A holds in advance one or more sets of the identifier of the terminal and its MAC address, on the basis of the input from a system manager or the like, as well as the storing of the set outputted from the IP address obtaining means 14. Also, the retrieval can be executed from the capsulation means 12A.

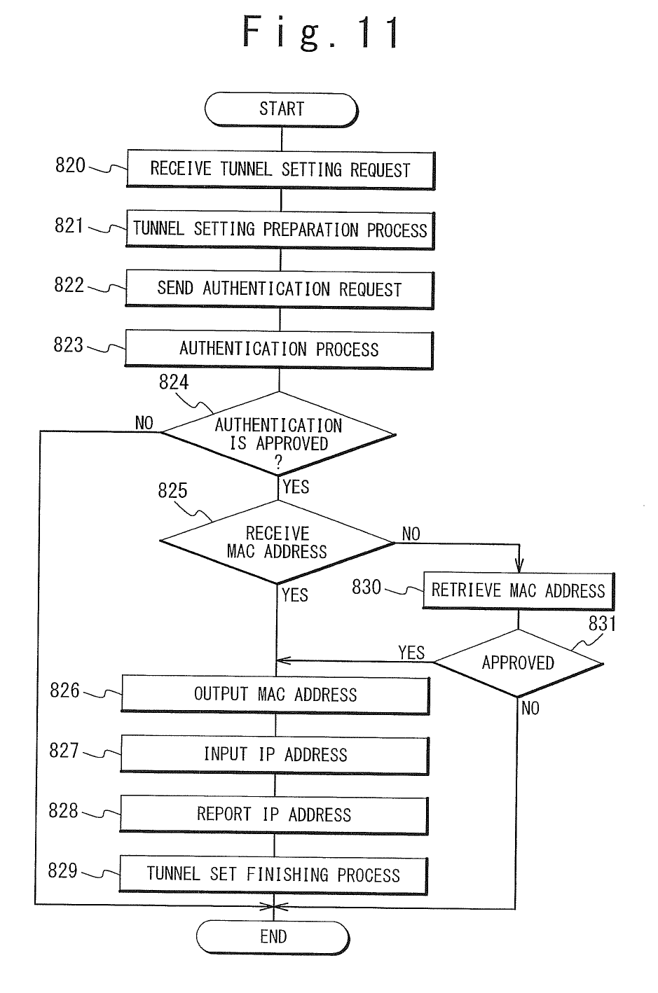

As shown in the flowchart of FIG. 11, the capsulation means 12A, if the MAC address is not reported from the user terminal apparatus 2 after the user terminal apparatus 2 requesting the setting of the communication tunnel is authenticated (no at Step 825), retrieves the terminal address holding means 15A by using the identifier of the user terminal apparatus 2 being authenticated as the key (Step 830), and if the corresponding MAC address is registered in advance (yes at Step 831), outputs this registered MAC address to the IP address obtaining means 14 (Step 826).

The other configurations and operations are similar to those of the first embodiment.

According to this embodiment, even if there is a setting request for the communication tunnel from the user terminal apparatus 2 which does not have a MAC address reporting function, if the MAC address of the user terminal apparatus 2 is registered in advance in the tunneling apparatus 1, it is possible to assign a fixed IP address corresponding to the MAC address.

In the above-mentioned explanations, the terminal address holding means 15A is commonly used as the storage unit for storing in advance the MAC address. However, the set of the identifier and MAC address of the user terminal apparatus may be held in a storage unit other than the terminal address holding means 15A. Also, the data combined with the MAC address to form a set may not the identifier of the user terminal apparatus but a data (a certification and the like) specific to the terminal that is obtained as the result of the authentication process and the authentication information of PPTP or IPsec.

The embodiments of the present invention have been described as mentioned above. However, the present invention is not limited to the above-mentioned embodiments and other various additional modifications can be made. Also, in the tunneling apparatus and user terminal apparatus of the present invention, their functions can be attained in a hardware manner. Alternatively, they can be attained by using a computer, a program for the tunneling apparatus and a program for the user terminal apparatus. The program for the tunneling apparatus is provided while this is recorded on a computer readable recording medium, such as the magnetic disc, the semiconductor memory and the like, and read by the computer when the computer constituting the tunneling apparatus is started up, and the operations of the computer are controlled by the program, which enables the computer to function as the various functional units of the tunneling apparatus 1 in the above-mentioned respective embodiments. Also, the program for the user terminal apparatus is provided while this is recorded on a computer readable recording medium, such as the magnetic disc, the semiconductor memory and the like, and read by the computer when the computer constituting the user terminal apparatus is started up, and the operations of the computer are controlled by the program, which enables the computer to function as the various functional units of the user terminal apparatus 2 in the above-mentioned respective embodiments.

1. An IP address assigning method of a remote access system comprising the steps of:
(a) a terminal apparatus connected to a first network requesting a setting of a communication tunnel to a tunneling apparatus connected to the first network and a second network for remote accessing the second network;
(b) the tunneling apparatus obtaining a MAC address of the terminal network;
(c) the tunneling apparatus sending a DHCP message including the MAC address of the terminal apparatus to the second network;
(d) a DHCP server connected to the second network receiving the DHCP message and sending a response message including an IP address being preliminary set correspondingly to the MAC address included in the received DHCP message to the second network; and
(e) the tunneling apparatus receiving the response message and reporting the IP address included in the received response message to the terminal apparatus.

2. The IP address assigning method of the remote access system according to claim 1, wherein the tunneling apparatus sets the MAC address of the terminal apparatus as a transmission source address and adds the transmission source address to the DHCP server at the step (c),
the DHCP server sets the MAC address of the terminal apparatus as a transmission destination MAC address in the response message at the step (d), and
the tunneling apparatus receives the response message in a promiscuous mode at the step (e).

3. The IP address assigning method of the remote access system according to claim 1, wherein the step (b) includes:
the tunneling apparatus receiving the MAC address of the terminal apparatus being sent from the terminal apparatus to the tunneling apparatus.

4. The IP address assigning method of the remote access system according to claim 3, wherein the communication tunnel is set in an IPsec tunnel mode, and the terminal apparatus sends the MAC address to the tunneling apparatus in an IKE mode configuration.

5. The IP address assigning method of the remote access system according to claim 3, wherein the communication tunnel is set in an IPsec tunnel mode, and the terminal apparatus sends the MAC address of an own terminal apparatus to the tunneling apparatus by including the MAC address in an ISAKMP SA proposal.

6. The IP address assigning method of the remote access system according to claim 1, wherein the tunneling apparatus has a storing unit configured to store the MAC address of the remote access system, and
the step (b) includes retrieving the MAC address of the terminal apparatus which requests the setting of the communication tunnel from the storing unit.

7. A tunneling apparatus comprising:
an IP address obtaining unit configured to send a DHCP message including an input MAC address to a second network, to receive a response message when a DHCP server apparatus receiving the DHCP message sent by the IP address obtaining unit has sent the response message which includes an IP address being preset correspondingly to the input MAC address included in the DHCP message to the second network, and to output the IP address included in the response message; and
a capsulation unit configured to set a communication tunnel connecting the first network and the second network, obtaining a MAC address of a terminal apparatus connected to the first network when the terminal apparatus requests a setting of the communication tunnel, to output the obtained MAC address of the terminal apparatus as the input MAC address to the IP address obtaining unit, and to report an IP address outputted by the IP address obtaining unit to the terminal apparatus.

8. The tunneling apparatus according to claim 7, wherein the IP address obtaining unit sets the input MAC address as a transmission source MAC address of the DHCP message and receives the response message in a promiscuous mode.

9. The tunneling apparatus according to claim 7, wherein the capsulation unit obtains the MAC address of the terminal apparatus by receiving the MAC address of the terminal apparatus sent from the terminal apparatus to the tunneling apparatus.

10. The tunneling apparatus according to claim 7, further comprising a storage unit configured to store the MAC address of the terminal apparatus,
wherein the capsulation unit retrieve the MAC address of the terminal apparatus from the storage unit when the terminal apparatus requests a setting of the communication tunnel.

11. A terminal apparatus comprising:
a MAC address reporting unit configured to report a MAC address assigned to a physical network interface of a terminal apparatus to a tunneling apparatus when the terminal apparatus requests a setting of a communication tunnel to the tunneling apparatus for connecting a first network to a second network via the tunneling apparatus; and
an IP address setting unit configured to receive an IP address from the tunneling apparatus and to assign the received IP address to a network interface for the communication tunnel.

12. The terminal apparatus according to claim 11, wherein the communication tunnel is set in an IPsec tunnel mode, and the MAC address setting unit sends the MAC address to the tunneling apparatus in an IKE mode configuration.

13. The terminal apparatus according to claim 11, wherein the communication tunnel is set in an IPsec tunnel mode, and the MAC address setting unit sends the MAC address of the terminal apparatus to the tunneling apparatus by including the MAC address in a proposal of ISAKMP SA.
